(19) United States
(12) Patent Application Publication
(10) Pub. No.: US 2013/0031260 A1
(43) Pub. Date: Jan. 31, 2013

(54) METHOD AND APPARATUS FOR ESTABLISHING AN AD-HOC BI-DIRECTIONAL NETWORK WITH AN OPTICAL IDENTIFIER

(71) Applicant: Benjamin Tally Jones, Henderson, NV (US)

(72) Inventor: Benjamin Tally Jones, Henderson, NV (US)

(21) Appl. No.: 13/190,862

(22) Filed: Jul. 26, 2011

(51) Int. Cl. G06F 15/16

(52) U.S. Cl. 709/228

(57) ABSTRACT

A method of managing the establishment of a bi-directional communication session between a first client device and at least a second client device comprising receiving data from the first and the second client devices. The reception of data from the first client device establishes a presence of the first client device on a network where the first client device has a first identification. The reception of data from the second client device establishes a presence of the second client device on a network where the second client device has a second identification. The embodiment also includes transmitting an optical identifier signal to the first client device, wherein the optical identifier signal enables the first client device to display an optical identifier comprising the first identification encoded therein. The optical identifier facilitates the establishment of the bi-directional communication session between the first and the second client devices.

### BACKGROUND

The present application relates generally to the field of networking and more specifically to the establishment of a bi-directional communication session between a local network element and a remote element, especially as used in relation to authentication.

In order to more readily share information and communicate between electronic devices, such as computers, the devices are often communicatively linked to each other in what is generally referred to as a network. Today, networks span complicated telephone connections, simple home local networks, and everything in between to take advantage of the utility of the concept of linking electronic devices for data sharing and communication.

The Internet is a commonly-used network relied upon by more than a billion users around the world. The Internet is a world-wide system of interconnected devices and networks linked to one another through the TCP/IP protocol.

Today more than ever, small handheld devices, such a mobile phones, are viable portals to the Internet. For instance, mobile phones can access the Internet via built-in browsers configured to communicate directly with HTTP servers and display content on the mobile phone's display. Additionally, mobile phones are often powerful devices that are capable of running programs that allow the phone to interact on the Internet. For instance, a mobile phone application may include the functionality of making a purchase via the Internet. In another example, a mobile phone application may allow the user to make and receive audiovisual calls over the Internet.

Two dimensional optical codes, such as QR codes, can contain embedded data, such as a URL, and thereby direct a client device to a remote server. For instance, a QR code can include a URL to a website, and scanning the QR code with a properly configured client device will send the client device's browser to the URL in question.

Typically, establishing a bi-directional communication session between a client device and a remote device necessitates downloading and installing a dedicated client application. This requires installation, configuration, as well as authentication credentials that must be installed or provided by the user at runtime.

Alternatively, establishing a bi-directional communication session between a client device and a remote device, or two or more client devices, may be achieved by connecting the client device to hardware solutions that include special functionality. However, this is both cumbersome and expensive.

When two or more devices connect to each other, when one device is prompted to transmit secure information, and more and more as sensitive devices are designed to interact in larger networks or systems, it is important to protect sensitive information and property as much as possible. This security is typically achieved through methods of authentication, and authentication is typically broken down into knowledge, ownership, and inherence factors. For example, typically one logs into a web-based email account using single-factor authentication based on knowledge factors: the knowledge of the email address and password combination. Typically, more secure authentication requires at least two factors. For example, some secure bank accounts require knowledge factors—such as an account number and a password—and ownership factors—such as a series of numbers as derived by a hardware OTP (one time password) generator issued to the account holder.

Typically, for devices to authenticate based on ownership factors, the devices need to include near field communication (NFC) functionality. The addition of NFC or OTP capabilities to a device adds costs.

### SUMMARY

There is a need for a client device to be able to readily establish a bi-directional communication session with a remote device or server without installing a dedicated client application or using a specialty hardware solution. There is a need for a client device that can use multi-factor authentication to establish a bi-directional communication between devices.

According to one embodiment, a method of managing the establishment of a bi-directional communication session between a first client device and at least a second client device comprises receiving data from the first client device and receiving data from the second client device. The reception of data from the first client device establishes a presence of the first client device on a network where the first client device has a first identification. The reception of data from the second client device establishes a presence of the second client device on a network where the second client device has a second identification. The embodiment also includes transmitting an optical identifier signal to the first client device, wherein the optical identifier signal enables the first client device to display an optical identifier comprising the first identification encoded therein. The optical identifier is configured to facilitate the establishment of the bi-directional communication session between the first client device and the second client device.

In another embodiment, a method of establishing a bi-directional communication session between a first device and a second device comprises instantiating a software component on the first device, displaying an optical identifier on the first device, receiving data from the second device, and emitting an audiovisual or haptic indicator on the first device upon establishment of the bi-directional communication session. According to this embodiment, the software component is associated with a first identification, and the optical identifier displayed on the first device includes the first identification encoded therein. The reception of data from the second device, occurring after the second device scans the displayed optical identifier, thereby facilitates the establishment of the bi-directional communication session between the first device and second device.

In yet another embodiment, a method of establishing a bi-directional communication session between a first device and a second device comprises transmitting data to a remote server, scanning with the second device an optical identifier displayed on the first device, facilitating the establishment of a bi-directional communication session between the first and second device using a session-specific identification encoded in the optical identifier, and emitting an audiovisual or haptic indicator on the second device upon establishment of the bi-directional communication session. The transmission of data to the remote server establishes a presence of the second device on a network and wherein the remote server and the first device comprise separate devices. According to this embodiment, the bi-directional communication session enables direct communication exchange between the first and second devices.

These and other embodiments of the present application will be discussed more fully in the detailed description. The features, functions, and advantages can be achieved independently in various embodiments of the present application, or may be combined in yet other embodiments.

### BRIEF DESCRIPTION OF THE DRAWINGS

FIG. 1 is a block diagram that graphically represents the establishment of a bi-directional ad-hoc network related to an intermediary device.

FIG. 2 is a block diagram that graphically represents the establishment of a bi-directional ad-hoc network between a client device and a remote server by way of an optical identifier.

FIG. 3 is a block diagram representing different sub-units on an exemplary client device.

FIG. 4 shows a series of exemplary optical identifiers (4A-4D) that may be used in the establishment of an ad-hoc bi-directional network.

FIG. 5 is a flow chart representing certain exemplary steps taken in establishing an ad-hoc bi-directional network.

FIG. 6 is a flow chart representing certain exemplary steps taken in establishing an ad-hoc bi-directional network.

FIG. 7 is a flow chart representing certain exemplary steps taken in establishing an ad-hoc bi-directional network.

FIG. 8 is a block diagram representing a many-to-many bi-directional relationship.

FIG. 9 shows an exemplary connection indicator.

FIG. 10 shows a block diagram of certain modules for an Identifier Reader Application.

Like reference numbers and designations in the various drawings indicate like elements.

### DETAILED DESCRIPTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

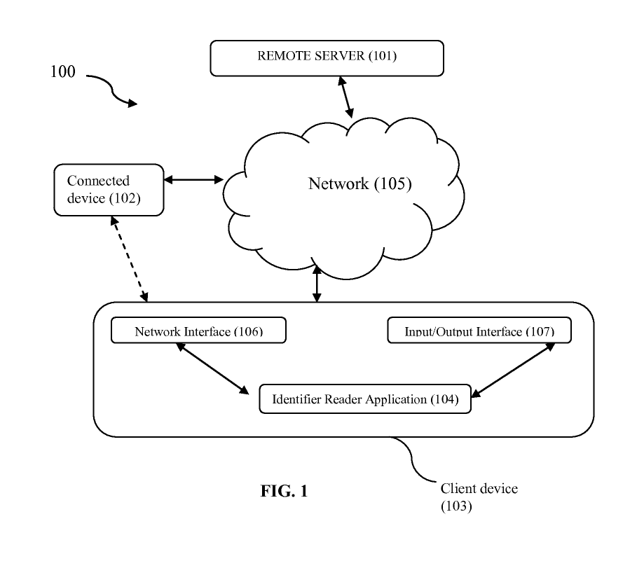

FIG. 1 shows an overview of a system 100 comprising remote and local elements. In the illustrated embodiment, the system 100 comprises a remote server 101 that is connected through a network 105, to a connected device 102 and a client device 103. As shown, the client device 103 includes a network interface module 106, an input/output interface module 107, and an identifier reader application 104.

In some embodiments, the remote server 101 may comprise, among other things, a remote XMPP server, an HTTP server, a barcode generator, any other suitable remote server variation, or any combination thereof. The connection of the remote server 101 to the network 105 can comprise any form or combination of wired or wireless connection. For example, the connection may be a coaxial connection, an Ethernet connection, or a cellular connection, among other things. The network 105 can be any suitable telecommunications network, such as, for example, the Internet, a WAN, a LAN, and an intranet network, among other things.

In some embodiments, the connected device 102 is also connected to the network 105, and the connection can include a wired connection, such as xDSL, coaxial cable, and fiber optic connections, or a wireless connection including Wi-Fi, 3G, CDMA, LTE, and HSPA+ protocols, among other things. The connected device 102 can be a computer attached to a network, a handheld device such as a telephone or a tablet PC, an embedded system device, or some other device configured to access the network 105.

In some embodiments, the client device 103 includes a network interface 106, an input/output interface 107, and an identifier reader application 104. The identifier reader application 104 can be configured to transmit and receive data, directly or indirectly, from the network interface 106 of the client device 103, or the input/output interface 107. The network interface 106 can interface with any form of network connection including an Ethernet connection, a Wi-Fi connection, and a cellular connection, among other things. The input/output interface 107 can be some form of interface that allows the client device 103 to access the network 105 or another device. For example, the input/output interface 107 can be some form of USB, firewire, or other proprietary connection system. In some embodiments, the client device 103 can be a computer, mobile phone, and industrial scanner, reader, or sensor, among other things.

In operation, the connected device 102 can be used to establish a bi-directional communication session between the client device 103 and the connected device 102 through the network 105. In one embodiment, the client device 103 and the connected device 102 can both be connected to the Internet through a LAN. According to one embodiment, the bi-directional communication session between the connected device 102 and the client device 103 can be pruned or pushed to the LAN. A session is an interactive information exchange, dialog, conversation, or meeting between two or more communicating devices. In one embodiment, the connected device 102 can be a public computer terminal with access to the Internet. In another embodiment, the connected device 102 can be a kiosk in a shopping center. A browser can be used to access a website on the connected device 102. The website can contain a software component 208 that initiates the establishment of a communication session with the remote server 101.

In one embodiment, the software component 208 may be a JavaScript-based component. In some embodiments, the software component 208 can be a dynamic or session-specific component. In embodiments where the component 208 is dynamic, the remote server 101 can assign an identification associated with the instance of the software component 208 to the connected device 102. In related embodiments, the identification may be generated locally on the connected device 102. In one embodiment, the identification of the software component 208 may comprise an XMPP jabber identification (JID). The remote server 101 can also transmit a static or dynamically created optical identifier 210, via an optical identifier signal, to the connected device, wherein the optical identifier can include the identification of the software component 208. Alternatively, the optical identifier 210 can be generated locally. The connected device 102 can display the optical identifier 210 on its screen or display.

In operation, the client device 103 can initiate the identifier reader application 104 and can scan the optical identifier 210, represented by the broken line in FIG. 1, displayed by the connected device 102. The identifier reader application 104 can use the optical identifier 210 to facilitate the establishment of a bi-directional communication session between the client device 103 and the connected device 102. In one embodiment, the client device 103 transmits data extracted from the optical identifier to the server 101 to facilitate the establishment of a bi-directional communication session with the software component 208. In another embodiment, the remote server 101 pushes addressing data to the client device 103 thereby allowing the client device 103 to attempt to contact the connected device 102 over the LAN after the client device 103 scans the optical identifier 210.

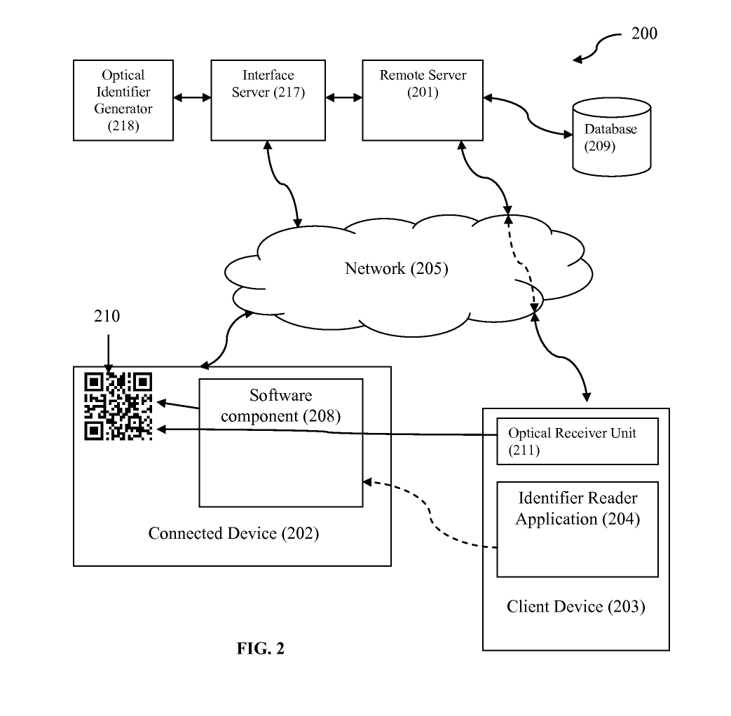

FIG. 2 shows one embodiment of a network system schematic 200 that includes both remote and local elements. In this embodiment, the remote elements include a remote server 201, connected to an interface server 217, an optical identifier generator 218 also coupled to the other remote elements, and a database 209. In one embodiment, the remote elements 201, 209, 217, and 218 may be connected so as to permit the transmission and reception of data between the elements. In one embodiment, the remote elements are connected, via the interface server 217, to a network 205. Also connected to the network 205 is a connected device 202. According to one embodiment, the connected device 202 includes a software component 208 and an optical identifier 210. In one embodiment, a client device 203 is connected to a network 205 and in turn to remote server 201. In some embodiments, the client device 203 includes an optical receiver unit 211 which is configured to capture the optical identifier 210, and an identifier reader application 204, which is configured to use the captured optical identifier 210 to facilitate the establishment of a bi-directional communication session between the client device 203 and the software component 208.

In one embodiment, the remote server 201, the interface server 217, the optical identifier generator 218, and the database 209 are connected to each other and can exchange data or information as with each other. According to another embodiment, the remote server 201, the interface server 217, the optical generator 218, and the database 209 can all reside on the same server or piece of hardware. According to other embodiments, however, the remote server 201 can be remote as to at least one of the interface server 217, the optical identifier generator 218, and the database 209, and the connection can be either wired or wireless.

In one embodiment, the remote server 201 can be configured to assign an identification to connected devices (e.g. 202) via software components (e.g. 208). According to some embodiments, the server 201 can be an XMPP server, and the identification of the software component 208 can be an XMPP jabber identification (JID). According to other embodiments, the server 201 can be any form of server configured to manage and/or facilitate communication between devices on a network, and the identification of the software component 208 can be any form of static, random, and/or temporary identification capable of identifying a software component 208 on the network. The remote server 201 can also facilitate the creation and transmission of an optical identifier (e.g. 210) as from the optical identifier generator 218 and the interface server 217, respectively. According to some embodiments, the interface server 217 is an HTTP server. The network 205 can be the Internet, a WAN, a LAN, a VPN, or an intranet network, among other things.

In one embodiment, the remote server 201 can accept and facilitate connections with client devices (e.g. 203). According to some embodiments, these connections can be XMPP connections, among other things, where the client devices (e.g. 203) are assigned static, dynamic, and/or temporary jabber identifiers (JID). In one embodiment, the identification of the client device 203 can be determined based upon the device's unique identifier (UID) and can be assigned when the identifier reader application 204 is installed on the client device 203. According to some embodiments, when the identifier reader application 204 is initialized on the client device 203, the identifier reader application 204 sends a data packet to the remote server 201 to inform the remote server 201 that the identifier reader application 204 associated with the UID of the client device 203 is available to communicate, or receive and transmit data, on the network. In some embodiments, the identification of the client device 203 can be dynamically assigned or generated when the identifier reader application 204 is launched and/or connects to the remote server 201.

According to some embodiments, the connected device 202 can be a computer, tablet, handheld device, or embedded system device connected to the network 205. The connected device 202 can be configured to launch or open a software component 208 by which it is assigned an optical identifier 210. In some embodiments, the connected device 202 can then display the optical identifier 210 by way of a screen or other display-like output mechanism. In one embodiment, the software component 208 can be a JavaScript component running in a browser. According to another embodiment, the software component 203 can be any other form of components configured to communicate, directly or indirectly, with a remote server 201. In one embodiment, the software component 208 can establish a communication session via the network 205 with the remote server 201. The communication session can be a bi-directional stream over synchronous http (BOSH) connection. According to this embodiment, the software component 208 can receive a unique, session-specific identification, for instance, an XMPP jabber identification (JID), that identifies the connected device 202 and/or the software component 208. The optical identifier 210 can be any type of optical identifier that can encode the identification of the software component 208 therein. It can be a one or two-dimensional code like a bar code or a QR code, it can be an image, or any other optical identifier.

According to some embodiments, the client device 203 can be a computer, a handheld device such as a mobile phone or tablet, an industrial scanner, reader or a sensor. The client device 203 can include an optical receiver unit 211 which can be a camera or some other optical sensor. The identifier reader application 204 can be a module, program, or application, among other things, on the client device 203 configured to manage the communication session with the remote server 201 and/or the connected device 202. In one embodiment, the identifier reader application 204 can be configured to facilitate the establishment of a communication session with the software component 208, via an identifier unique to the client device 203. In one embodiment, this identifier can be an XMPP JID. In one embodiment, the communication session can be a XMPP socket connection. In another embodiment, the communication session can be a BOSH connection.

According to some embodiments, the optical receiver unit 211 of the client device 203 can transmit optical data to the identifier reader application 204. In one embodiment, the transmitted data can include an optical identifier 210 from a connected device 202. In turn, the identifier reader application 204 can use the optical identifier 210 in order to facilitate the establishment of a bi-directional communication session between the client device 203 and the software component 208 running on the connected device 202. In one embodiment, the client device 203 can include a second optical receiver unit 211 such that the client device 203 has both a front-facing and a rear-facing optical receiver unit 211. In this embodiment, the identifier reader application 204 is configured to receive optical data from both optical receiver units 211 therefore permitting the identifier reader application 204 to use both a unique optical identifier 210 and the user's face in facilitating the establishment of a bi-directional communication session. The client device 203 can also be configured to gather and send other biometric data. For instance, in one embodiment the client device 203 can capture an image of the user using a rear-facing optical receiver unit 211 and/or capture and transmit other biometric data including fingerprints and palm prints among other physiological characteristics. The client device 203 can transmit the image and/or other biometric data to the remote server 201 where the server can verify the identity of the user, based on the image and/or other biometric data, and as against a sample image stored in a database 209. In one embodiment, the client device 203 and the identifier reader application 204 can be configured to give audiovisual and/or haptic feedback to the user when the user scans an optical identifier 210 and/or creates a connection to a software component 208.

In operation, the connected device 202 can open a website which launches a software component 208. Through the software component 208, the network 205, and an interface server 217, the connected device 202 can access a remote server 201. The software component 208 can receive an identification from the remote server 201, or alternatively, it can log into the network using a static or pre-assigned identification. For instance, in one embodiment, the identification can be assigned locally by the software component 208. In one embodiment, the remote server 201 can prompt the optical identification generator 218 to generate a dynamic or static optical identifier 210 that encodes the dynamic or static identification of the connected device 202. The optical identifier 210 can be transmitted through the interface server 217 and the network 205 to the software component 208. Alternatively, the optical identifier 210 can be generated locally by the software component 208. In one embodiment, the remote server 201 can transmit an optical identifier (ID) signal to the software component 208. The optical ID signal can comprise the binary representation of the optical identifier, or the optical ID signal can comprise the binary representation of the code used to generate the optical identifier locally on the software component 208. The connected device 202 can display the optical identifier 210. A client device 203 can load an identifier reader application 204, where the identifier reader application can be configured to negotiate a communication session with the remote server 201. The identifier reader application 204 can prompt the optical receiver unit 211 of the client device 203 to scan the optical identifier 210 of the connected device 202. The identifier reader application 204 can decode the optical identifier 210 to retrieve the identification of the software component 208. The identifier reader application 204 can use the identification of the software component 208 to facilitate a bi-directional communication session between the client device 203 and the software component 208. In some embodiments, in response to the creation of a bi-directional communication session between the client device 203 and the software component 208, the connected device 202 can emit an audiovisual indicator and/or the connected device 202 can cease displaying the optical identifier 210. In some embodiments, when the client device 203 and the software component establish a bi-directional communication session, the client device 203 can be configured to emit an audiovisual or haptic indicator, such as a chime, displaying a graphic, changing the color of an icon, or having the client device 203 vibrate.

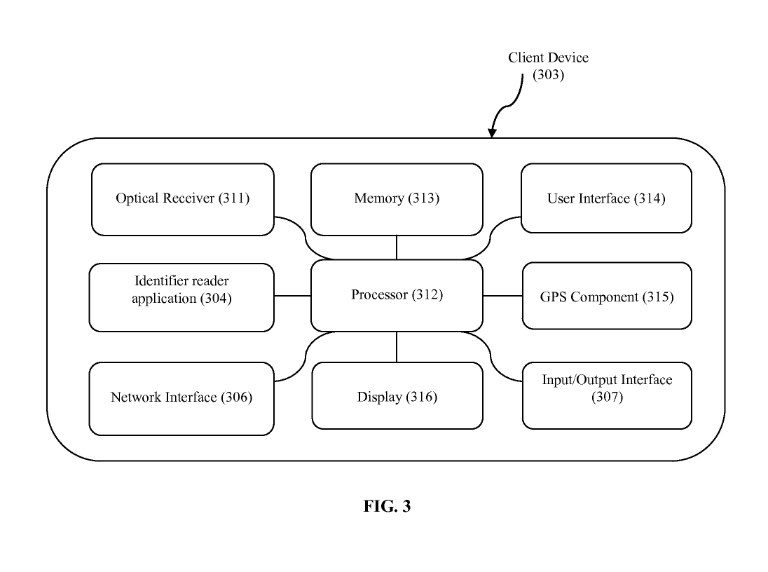

FIG. 3 shows a block diagram of an exemplary embodiment of the client device 303. In this embodiment, the client device 303 includes a processor 312 coupled with an optical receiver 311, an identifier reader application 304, and a network interface 306. The processor 312 is also connected to a memory 313, a display 316, a user interface 314, a GPS component 315, and an input/output interface 307.

In operation, the user interface 314 can be manipulated in order launch or open the identifier reader application 304, among other things. The identifier reader application 304 can be an embedded module on the client device 303 or it can be loaded into the client device's memory 313. The display 316 can be configured to display the user interface 314 and/or identifier reader application 304 functionality. In one embodiment, the identifier reader application 304 can use the network interface 306 and/or the input/output interface 307 in order to facilitate the establishment of a connection or communication session with a remote server (e.g. 201). The connection can be an XMPP socket connection, a BOSH connection, or some other connection or communication session where the client device 303 and/or the identifier reader application 304 can be identified based on a static, dynamic, and/or temporary identification. In one embodiment, the identification can be an XMPP JID that is assigned to the client device's instance of the identifier reader application 304.

In one embodiment, the identifier reader application 304 can use the optical receiver 311 in order to read, scan, and capture optical data from a connected device 202. The optical receiver 311 can be configured to transmit optical data to the processor 312, memory 313, display 313, network interface 306, input/output interface 307, and/or identification reader application 304, among other things. The identification reader application 304 can use the captured optical data in order to decode identification data embedded in an optical identifier 210. In one embodiment, the identification reader application 304 can use the embedded identification in order to facilitate a bi-directional communication session between the client device 303 and a software component 208 running on a connected device 202. In one embodiment, the identification reader application 304 can transmit the identification of the software component 208 to the network interface 306 or the input/output interface 307, which can, in turn, transmit the data through the network 205 and on to the remote server 201. In one embodiment, the remote server 201 can use the identification of the software component 208, as transmitted from the client device 303, and the client device's own static identifier in order to facilitate the establishment of a bi-directional communication session between the client device 303 and a software component 208. In another embodiment, the remote server 201 can push addressing data in relation to the software component 208 to the client device 303, and the client device 303 can use the addressing data in order to attempt to establish a bi-directional communication session directly with the software component 208. In one embodiment, client device 303 can transmit a hello signal to the connected device 202 and/or software component 208. In that embodiment, the software component 208 can respond to the client device 303. The hello signal can be any combination of hello, identification, or handshake signals that can be used to facilitate a bi-directional communication session.

In a further embodiment, the client device can also include a GPS component 315 which can be configured to provide geospatial location data to the processor 312, memory 313, identifier reader application 304, network interface 306, and/or input/output interface 307, and which can additionally be transmitted to the remote server 201 or the software component 208.

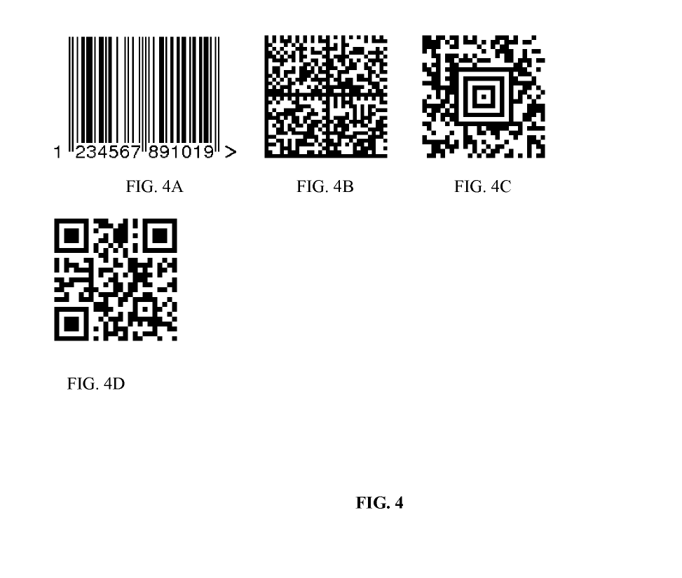

FIGS. 4A-4D show a handful of common optical identifiers, or optical codes, which are in use and that might be used according to certain embodiments of the current application. FIG. 4A shows a common bar code, or one-dimensional optical code. Numerical data can be encoded in a bar code by, among other things, the width, spacing, and regularity of the vertical bars. Bar codes can also include the numerical equivalences underneath the bars, as shown in FIG. 4A with “1 234567891019”. FIG. 4B shows a two-dimensional or matrix code where alpha-numerical data can be embedded in both the x- and y-axes. FIG. 4C shows another possible embodiment of a two dimensional optical code. In this embodiment, in addition to the two dimensional matrix, there are central concentric squares that can also contain alpha-numeric data. FIG. 4D shows a common form of two dimensional optical codes, often referred to as a QR code, which can encode alpha-numeric data including URLs. FIGS. 4A-4D are examples of possible optical identifiers, however, one skilled in the art would readily recognize that any image or optical identifier can be suitable for embedding identification data and may therefore be suitable for use according to the disclosure of the current application.

In operation, an optical identifier generator 218 can create an optical identifier, such as one of 4A to 4D. The optical identifier generator 218 can create the optical identifier dynamically based upon a session-specific identification of a connected device 202. In one embodiment, the dynamically generated optical identifier (e.g. FIG. 4D) is transmitted via the interface server 217 to the connected device 202 for display. In another embodiment, the optical identifier is generated locally by the software component 208. In one embodiment, a client device 203 can scan or read the optical identifier (e.g. FIG. 4D), decode the identification data, and use that data in order to facilitate the creation of a bi-directional communication session between a client device 203 and a software component 208.

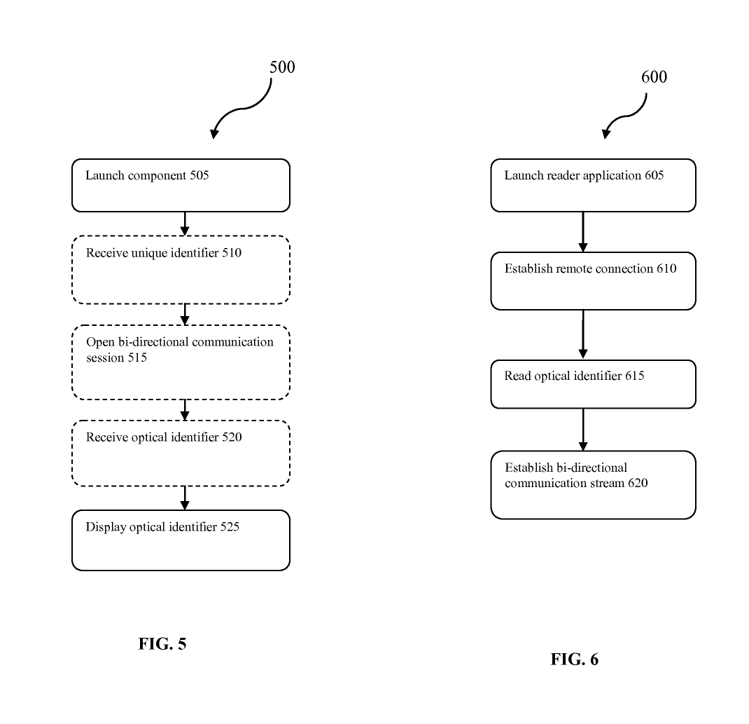

FIG. 5 is a flow chart illustrating one exemplary method 500 of launching a software component 208 and displaying an optical identifier 210 that can be implemented on a connected device 202. In a first step 505, the connected device 202 launches or instantiates a suitable software component 208. For example, in one embodiment, the software component 208 can be a JavaScript component running in a browser on a connected device 202. In another embodiment, the software component 208 can launch on an embedded system device, such as a vehicular infotainment system, among other things.

In some embodiments, the method 500 includes an optional step 510, in which the connected device 202 can receive an identification. According to one embodiment, the identification of the software component 208 can be a XMPP JID, among other things, and can be static, dynamically generated, and/or assigned upon launch of the software component 208 and/or connection of the software component 208 to a remote server 201. In another optional step 515, the connected device 202 can open a bi-directional communication session with the remote server 201 or notify the remote server 201 of the presence of the connected device 202 on the network 100.

In a next optional step 520, the connected device 202 can receive an optical identifier 210 from the remove server 201 or other remote elements. In another embodiment, the software component 208 can generate the optical identifier 210 locally. The optical identifier 210 can have the identification of the software component 208 embedded into the identifier. In a next step 525, the connected device 202 can display the optical identifier 210 via a screen or any suitable display.

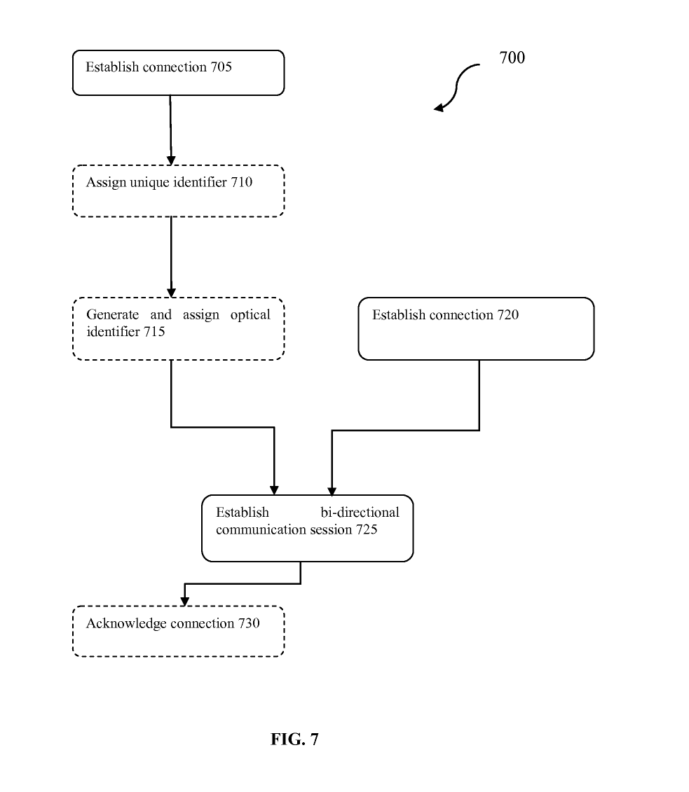

FIG. 6 is a flow chart illustrating one exemplary method 600 of establishing a bi-directional communication session from the perspective of a client device 203. In a first step 605, the identifier reader application 204 is launched or initiated on a client device 203. In one embodiment, the identifier reader application 204 can launch automatically when the client device 203 initializes, and in other embodiments, the identifier reader application 204 can launch at some point after the client device 203 initializes. In another step 610, the identifier reader application 204 can facilitate a connection to a remote server 201. In an alternative embodiment, the client device 203 can transmit data to the remote server 201 sufficient to notify the remote server 201 as to the presence of the client device 203 on the network. In one embodiment, the connection is a XMPP socket connection. In another embodiment, the connection is a BOSH connection. According to some embodiments, the client device 203 and/or the identifier reader application 204 can be assigned a static identifier by the remote server 201. In one embodiment, the static identifier is a XMPP JID that is assigned when the identifier reader application 204 is installed on a client device 203.

In another step 615, the optical receiver unit 211 can be configured to read an optical identifier 210. In one embodiment, the identifier reader application 204 can be configured to interact (i.e. transmit and receive data from) with the optical receiver unit 211 of the client device 203. The identifier reader application 204 can therefore receive optical data that can include embedded identification data of the software component 208. According to one embodiment, the identifier reader application 204 can actively recognize whether or not a scanned optical identifier 210 is a supported identifier and either prompt the optical receiver unit 211 to continue searching for supported optical identifiers, or instruct the optical receiver unit 211 to cease its search and power down and/or to enter a low power mode.

In another operational step 620, the identifier reader application 204 is configured to use identification data in order to facilitate the establishment of a bi-directional communication stream between the client device 203 and a software component 208 and/or a connected device 202. According to one embodiment, the client device 203 can use session information from the software component 208 of the connected device 202 in order to “join” the software component's session with the remote device 201. According to other embodiments, the client device 203 can use session information from the software component 208 of the connected device 202 in order to establish a bi-directional communication directly with the software component 208. According to one embodiment, the connected device 202 can be browsing an e-retailer's website that includes JavaScript code and that launches a software component 208 on the connected device 202. The connected device 202 can display an optical identifier 210, prompting the user to scan the optical identifier 210 with a supported device such as a smart phone or tablet pc (i.e. 203) running the identification reader application 204. In one embodiment, scanning the optical identifier 210 with a client device 203 can facilitate a bi-directional communication session between the software component 208 and/or the remote server 201 and the client device 203. In one embodiment, the bi-directional communication session could lead to the purchase of goods off of the e-retailer's website without the need of entering sensitive financial data into the connected device 202.

In another embodiment, the connected device 202 can be a computer connected through a warehouse's intranet network to a merchandise server (i.e. 201). In one embodiment, the connected device 202 can display an optical identifier 210 identifying the connected device's location and/or department. In one embodiment, industrial scanning mechanisms (i.e. 203) can read the optical identifier 210 off of the connected device 202 in order to facilitate the establishment of a bi-directional communication session between each of the industrial scanning mechanisms and the connected device 202 and/or the merchandise server 201. Among other things, the merchandise server 201 and the connected device 202 could therefore be aware of spatial and/or departmental location as to the industrial scanning mechanisms 203 and use that information to tailor the scanning mechanisms' functionality within the warehouse, while the industrial scanning mechanisms 203 can send data directly to the merchandise server 201 and/or the connected device 202. Of course, these examples are not to be taken in a limiting sense, but are meant to illustrate the breadth contemplated under the current application.

FIG. 7 is another flowchart illustrating one exemplary method 700 of using a client device 203 and a connected device 202 to facilitate, enable, and/or acknowledge a bi-directional communication session as between the client device 203 and a software component 208 running on the connected device 202. In a first step 705, the software component 208 and a remote server 201 negotiate a connection. According to one embodiment, a software component 208 is launched on a connected device 202.

According to some embodiments, the method 700 includes an optional step 710, in which the remote server 201 assigns an identification to the software component 208 and/or the connected device 202. According to other embodiments, the identification can be generated locally by the software component 208 or it can be static. In a next optional operational step 715, the remote server 201 manages the creation of a dynamic or unique session-specific optical identifier 210 and the transmission of the optical identifier 210 to the connected device 202. Alternatively, the optical identifier 210 can be generated locally or it can be static. The connected device 202 can then display the optical identifier 210.

In another method step 720, a client device 203 can establish a connection with a remote server 201, and/or otherwise indicate the presence of the client device 203 on the network with the remote server 201. In one embodiment, the identifier reader application 204 on the client device 203 can then prompt the scanning or reading of the optical identifier 210 displayed on the connected device 202. In a next operational step 725, the client device can use data embedded in the optical identifier 210 to establish a bi-directional communication session between the client device 203 and the software component 208 running on the connected device 202.

In some embodiments, the method 700 includes an optional step 730, in which the connected device 202 and the software component 208 can be configured to acknowledge the establishment of a bi-directional communication session by displaying a connection acknowledgement on its display or screen. According to some embodiments, the acknowledgement can also be an audiovisual or haptic indicator, such as a chime or vibration. In many embodiments, upon creation of the bi-directional communication session between the client device 203 and the software component 208, the connected device 202 can be configured to cease displaying the session-specific optical identifier.

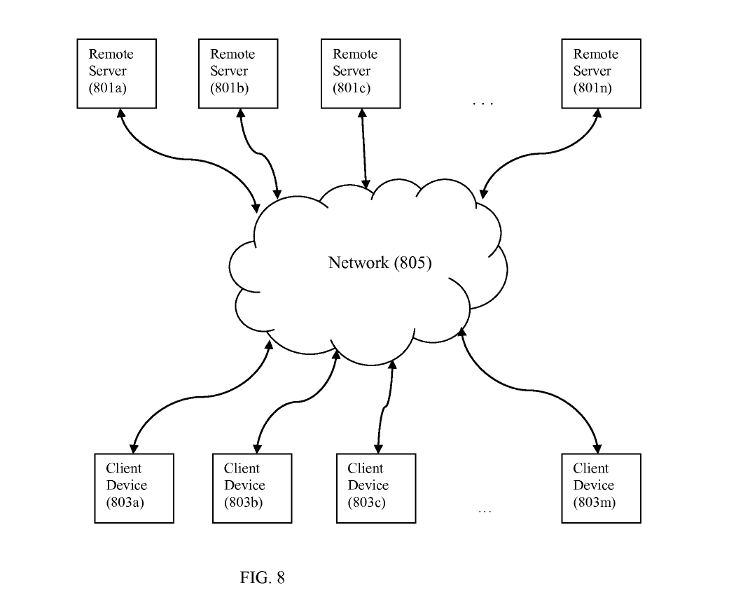

FIG. 8 is a block diagram showing an exemplary embodiment of a many-to-many bi-directional communication session between n-remote servers 801a-801n and m-client devices 803a-803m. As seen in FIG. 8, the remote servers 801a-801n and the client devices 803a-803m are connected through a network 805. In one embodiment, multiple client devices 803a-803m can establish a connection with a plurality of remote servers 801a-801n. In operation, these connections can be established as discussed above in the preceding examples and embodiments.

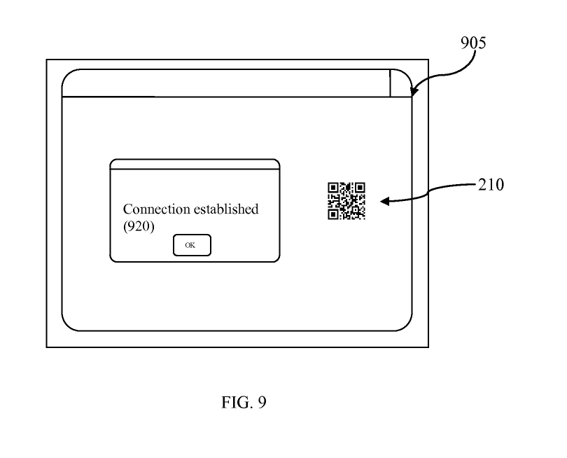

FIG. 9 shows an exemplary simulated screenshot of the connected device 202 when a connection has been established between a client device 203 and the connected device 202. In the embodiment shown in FIG. 9, the connected device 202 comprises a display 905, which displays an exemplary optical identifier 210 and a pop-up window 920 indicating that a bi-directional communication session has been established and prompting the user to react accordingly. In another embodiment, the connected device 202 can show a counter indicating the number of connections made based on the optical identifier 210. In another embodiment, the connected device 202 can display a predetermined color to acknowledge the establishment of a communication session. In another embodiment, the connected device 202 can display an icon suggestive of the establishment of a communication session. In another embodiment, the connected device 202 can emit an audible sound to indicate the establishment of a communication session. In yet another embodiment, the connected device 202 is configured to acknowledge the establishment of a connection via a haptic or sense-based response such as vibration.

In some embodiments, the information on the display 905 is outputted via a browser. A browser is a software application configured to retrieve, present, and traverse information resources on the World Wide Web, web servers, and file systems. Browsers rely on uniform resource identifiers of information resources to navigate to web pages and content resources such as images, videos, and sounds. Browsers are capable of running code on the local machine of the browser in order to interpret information resources that they encounter. For instance, a browser might navigate to a Uniform Resource Locator (URL) that contains information coded in HTML that the browser can interpret to determine how to display the content at the URL. In another example, in addition to HTML, a URL might also contain JavaScript code. JavaScript is a programming language that, as used on web sites, allows programmers to take advantage of advanced behaviors that are not directly supported by HTML and therefore achieve more robust functionality, more robust server- and/or client-side behaviors, and logical progressions, among other things. According to some embodiments, upon establishing a bi-directional communication session between the client device 203 and the connected device 202, the connected device 202 can cease to display the optical identifier 210.

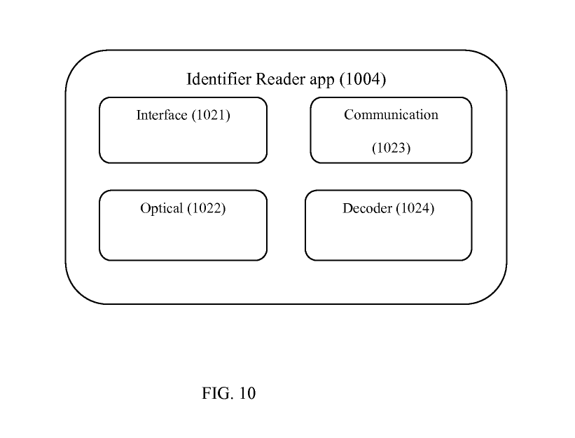

FIG. 10 shows a block diagram of elements that may make up the identifier reader application 1004. As shown in FIG. 10, and according to one embodiment, the identifier reader application 1004 includes an interface module 1021, an optical module 1022, a communication module 1023, and a decoder module 1024. In one embodiment, the interface module 1021 is configured to receive user input and interface with the client device's display 316. In one embodiment, the optical module 1022 is configured to interact with the optical receiver unit 211 and to transmit and receive data therefrom. In one embodiment, the decoder module 1024 is configured receive optical data from the optical module 1022 and decode the portions of the received optical data that contain an identification of the software component 208. In one embodiment, the communication module 1023 is configured to receive and transmit data through the network interface 306 and/or the input/output interface 307. The communication module 1023 can also send and receive data in relation to the identification of the software component 208.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A method of managing the establishment of a bi-directional communication session between a first client device and at least a second client device, the method comprising:
receiving data from the first client device, thereby establishing a presence of the first client device on a network, wherein the first client device has a first identification;
receiving data from the second client device, thereby establishing a presence of the second client device on the network, wherein the second client device has a second identification; and
transmitting an optical identifier signal to the first client device, wherein the optical identifier signal enables the first client device to display an optical identifier comprising the first identification encoded therein,
wherein the optical identifier is configured to facilitate the establishment of the bi-directional communication session between the first client device and the second client device.

2. The method of claim 1 further comprising transmitting addressing data corresponding to the first client device to the second client device.

3. The method of claim 1 wherein the first identification comprises a unique session-specific identification.

4. The method of claim 1 wherein the second identification comprises a unique session-specific identification.

5. The method of claim 1 further comprising:
receiving data from a third client device, thereby establishing a presence of the third client device on the network, wherein the third client device has a third identification; and
transmitting addressing data corresponding to the first client device to the third client device.

6. The method of claim 1 wherein receiving data from the first client device comprises assigning the first identification to the first client device.

7. The method of claim 1 wherein transmitting the optical identifier signal to the first client device comprises transmitting the optical identifier signal over the Internet.

8. The method of claim 1 wherein the optical identifier signal comprises a software module configured to enable the first client device to generate the optical identifier.

9. The method of claim 1 further comprising authenticating a user identity of a user operating the second client device with at least one inherence factor.

10. The method of claim 9 wherein authenticating the user identity comprises comparing an image or biometric data of the user received from the second client device with an image or biometric data stored in a database on the network.

11. A method of establishing a bi-directional communication session between a first device and a second device, the method comprising:
instantiating a software component on the first device, wherein the software component is associated with a first identification;
displaying an optical identifier on the first device, the optical identifier comprising the first identification encoded therein;
receiving data from the second device after the second device scans the displayed optical identifier, thereby facilitating the establishment of the bi-directional communication session between the first device and the second device; and
emitting an audiovisual or haptic indicator on the first device upon establishment of the bi-directional communication session.

12. The method of claim 11 further comprising receiving an optical identifier signal from a remote server, thereby enabling the first device to display the optical identifier.

13. The method of claim 11 further comprising ceasing to display the optical identifier upon establishment of the bi-directional communication session.

14. The method of claim 11 wherein instantiating the software component on the first device comprises directing a browser on the first device to a URL, and wherein the software component comprises a JavaScript component.

15. The method of claim 11 wherein receiving data from the second device comprises receiving a hello signal from the second device.

16. The method of claim 15 wherein facilitating the establishment of the bi-directional communication session comprises transmitting a response to the second device upon reception of the hello signal from the second device.

17. The method of claim 11 wherein the software component displays the optical identifier as an embedded element.

18. A method of establishing a bi-directional communication session between a first device and a second device, the method comprising:
transmitting data to a remote server, thereby establishing a presence of the second device on a network, wherein the remote server and the first device comprise separate devices;
scanning with the second device, an optical identifier displayed on the first device, wherein the optical identifier comprises an identification encoded therein;
facilitating the establishment of a bi-directional communication session between the first device and the second device using the identification encoded in the optical identifier; and
emitting an audiovisual or haptic indicator on the second device upon establishment of the bi-directional communication session,
wherein the bi-directional communication session enables direct communication exchange between the first and second devices.

19. The method of claim 18 further comprising:
receiving addressing data for the first device; and
transmitting a hello signal directly to the first device based upon the addressing data and the identification encoded within the optical identifier.

20. The method of claim 18 further comprising:
capturing an image or biometric data of a user of the second device with the second device; and
transmitting the image or biometric data to a remote server for authentication.

21. The method of claim 18 wherein, after the establishment of the bi-directional communication session, messages are transmitted between the first device and the second device without being routed through the remote server.
